(19) United States
(12) Patent Application Publication
(10) Pub. No.: US 2006/0121435 A1
(43) Pub. Date: Jun. 8, 2006

(54) System and method for individual development plan management

(76) Inventors: Hung-Chi Chen, Miaoli Hsien (TW); Chung-Ming Tai, Jhubei City (TW); Brian Feng, Hsinchu City (TW); Wei-Chin Tseng, Toufen Chen (TW); Anne Lin, Hsinchu City (TW); Debra Chang, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/005,632

(22) Filed: Dec. 6, 2004

(51) Int. Cl. G09B 7/00

(52) U.S. Cl. 434/362

(57) ABSTRACT

A system and method for individual development plan management. The system includes a platform integrating a training unit coupled to a planning unit. The training unit generates a training record. The planning unit has an individual development plan generated by collaboration between a client and a supervisor. The planning unit receives the training record, and generates an achievement result according to the individual development plan and the training record.

### BACKGROUND

The present invention relates to development plan management, and particularly to a system and method for individual development plan management that generates development plans and traces individual achievement.

Development of staff is important for enterprises. FIG. 1 shows a conventional setup and execution process of an individual development plan for individual staff members. In an enterprise, the professional development administration first prepares and introduces course briefs to each department (S101). Then, each department manager plans department training courses (training matrix) for his staff, and returns it (S102). After collecting information for departmental training courses for each department, the professional development administration begins to plan resource and schedule related courses (S103). After the course schedule is determined, the individual development plan for each staff member is set up by his supervisor according to corresponding departmental training courses (S104). Finally, each executes individual development plans by completing corresponding courses, and receives a corresponding training record (S105). Without a computerized mechanism, conventional planning process is inefficient, particularly for a large enterprise having many employees.

Additionally, since the entire training system incorporates planning and training units between whom no applications or connections exist, there is no way to manage and trace achievement for each staff member, thereby undermining the development purpose.

### SUMMARY

The present invention is proposed to address and solve the aforementioned issues.

Accordingly, it is an object of the present invention to provide a system and method for generating individual development plans by collaboration between individuals and supervisors.

It is another object of the present invention to provide a system and method for tracing achievement for individual development plans.

To achieve the above objects, the present invention provides a system for individual development plan management. The system includes a training unit coupled to a planning unit. The training unit generates a training record. The planning unit, which comprises an individual development plan generated by collaboration between a client and a supervisor, receives the training record, and generates an achievement result according to the individual development plan and the training record.

The training record records at least a completion date of a learning course, and the individual development plan records at least one development course and a corresponding allotted date. The planning unit ignores the training record if the course is not the development course, compares the completion date with the allotted date to generate the achievement result if the course is the development course, and transmits the achievement result to a supervisor via a network.

The client generates a course plan and transmits it to the supervisor. The supervisor transmits the course plan to the planning unit as the individual development plan if the course plan is approved, and returns the course plan to the client if the course plan is not approved.

According to another embodiment, a method for individual development plan management is provided. First, a training record is generated by a training unit. The training record records at least a completion date of a learning course. A planning unit coupled to the training unit is provided. The planning unit has an individual development plan recording at least one development course and a corresponding allotted date, and receives the training record from the training unit. An achievement result is generated according to the individual development plan and the training record.

Similarly, the planning unit compares the completion date with the allotted date to generate the achievement result if the course is the development course, and transmits the achievement result to a supervisor via a network. Further, the planning unit ignores the training record if the course is not the development course.

The individual development plan is generated by collaboration between a client and a supervisor. The client generates a course plan and transmits it to the supervisor. The supervisor transmits the course plan to the planning unit as the individual development plan if the course plan is approved, and returns the course plan to the client if the course plan is not approved.

The above-mentioned method may take the form of program code embodied in tangible media. When the program code is loaded into and executed by a machine, the machine becomes an apparatus for practicing the invention.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram illustrating the conventional setup and execution process of a development plan;

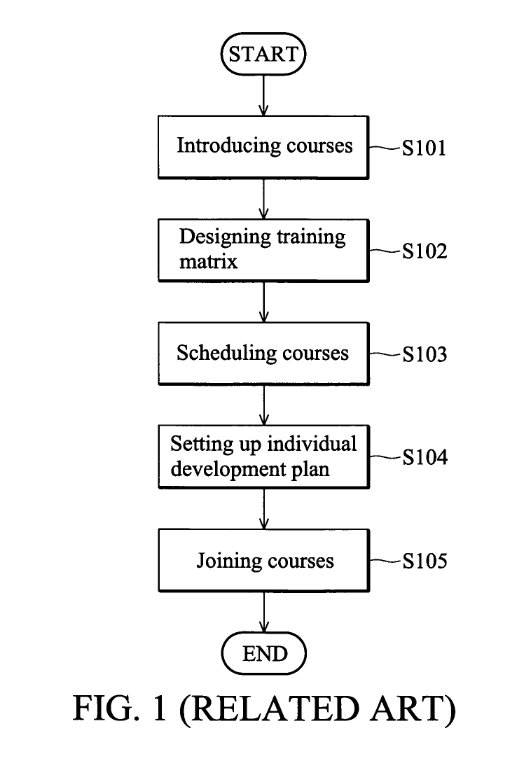

FIG. 2 is a schematic diagram illustrating the architecture of the system for individual development plan management according to the present invention;

FIG. 3 is a flowchart showing the process of individual development plan generation according to the present invention;

FIG. 4 is a flowchart showing the process of individual development plan modification by the client according to the present invention;

FIG. 5 is a flowchart showing the process of individual development plan modification by the supervisor according to the present invention;

FIG. 6 is a flowchart showing the process of the method for individual development plan management according to the present invention; and

FIG. 7 is a schematic diagram illustrating a storage medium storing a computer program for execution of the method for individual development plan management according to the present invention.

### DESCRIPTION

The present invention provides a system and method overcoming conventional development plan management problems.

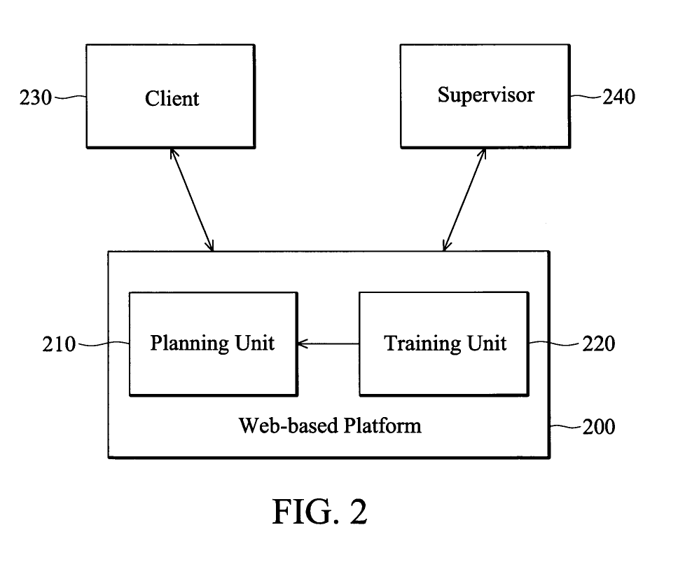

FIG. 2 illustrates the architecture of the system for individual development plan management according to the embodiment of the present invention. The system includes a web-based platform 200 integrating a training unit 220 and a planning unit 210 coupled to the training unit 220. The client (staff) 230 and supervisor 240 may log onto the platform 100 through a network.

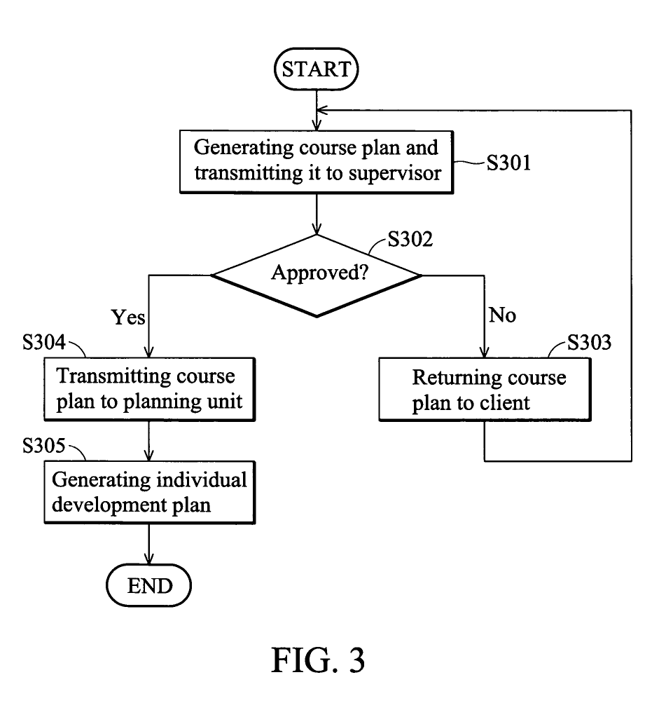

The planning unit 210 has at least one individual development plan of the client 230, generated by collaboration between the client 230 and the supervisor 240. The method of individual development plan generation is described in FIG. 3. The client 230 first logs onto the platform 200, and in step S301, generates a course plan recording at least one development course and a corresponding allotted date, and transmits it to the supervisor 240 for approval. If the course plan is not approved (No in step S302), in step S303, the supervisor 240 returns the course plan to the client 230, and the client 230 may generate another course plan. If the course plan is approved (Yes in step S302), in step S304, the supervisor 240 transmits the course plan to the planning unit 210, and in step S305, the planning unit 210 generates an individual development plan for the client 230. It is understood that the transmission of the course plan is forwarded via the platform 200.

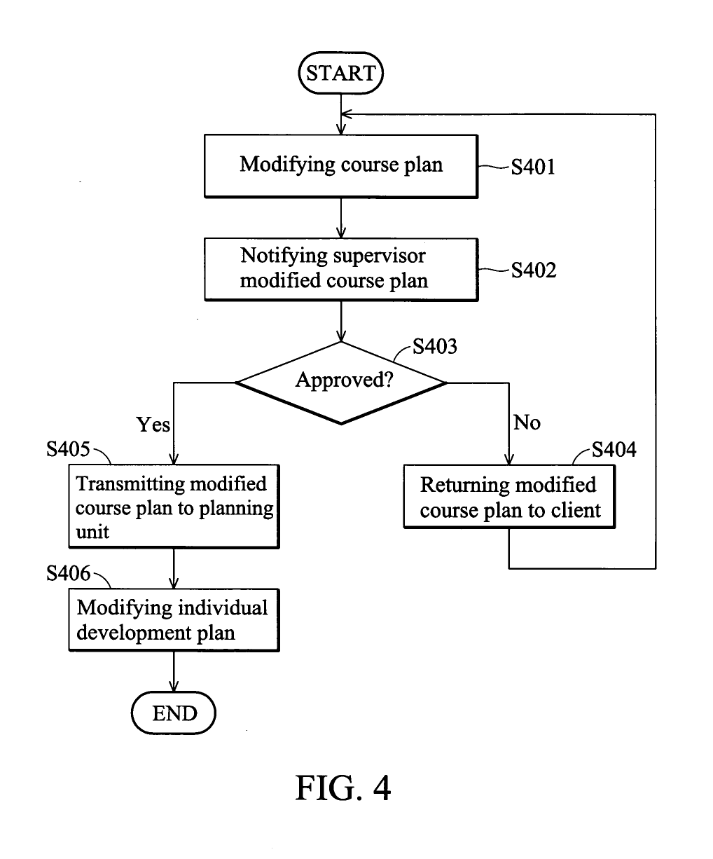

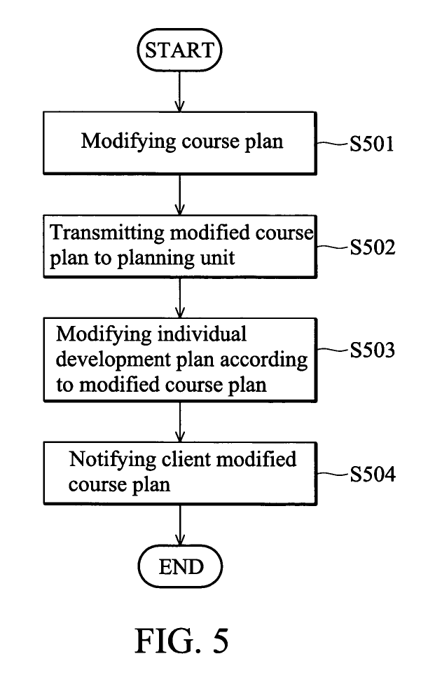

The procedures of individual development plan modification by the client 230 and supervisor 240 are described in FIGS. 4 and 5, respectively. Referring to FIG. 4, the client 230 first logs onto the platform 200, and in step S401, modifies the course plan. In step S402, the supervisor is notified of the modification by the platform 200, and receives the modified course plan for approval. If the modified course plan is not approved (No in step S403), in step S404, the supervisor 240 returns the modified course plan to the client 230, and the client 230 may make further modification. If the modified course plan is approved (Yes in step S403), in step S405, the supervisor 240 transmits the modified course plan to the planning unit 210, and in step S406, the planning unit 210 modifies the individual development plan according to the modified course plan.

Referring to FIG. 5, the supervisor 240 first logs onto the platform 200, and in step S501, modifies the course plan. In step S502, the supervisor 240 transmits the modified course plan to the planning unit 210, and in step S503, the planning unit 210 modifies the individual development plan according to the modified course plan. At the same time, in step S504, the client 230 is notified of the modification and the modified course plan by the platform 200.

It is noted that the platform 200 further provides interfaces with classified courses for helping clients to generate individual development plans. For example, the interfaces may be generated according to a training roadmap, core attributes, course category, or language preference. The training roadmap represents a series of courses for each department, and the core attributes represent the required course for each staff member.

After generating the individual development plan, the client 230 may commence related courses. The courses may be completed through electronic (e-learning), classroom, on-the job, or other training methods. The training unit 220 may be coupled to the training systems (not shown) to collect related information, such as training records of at least one course and corresponding completion date.

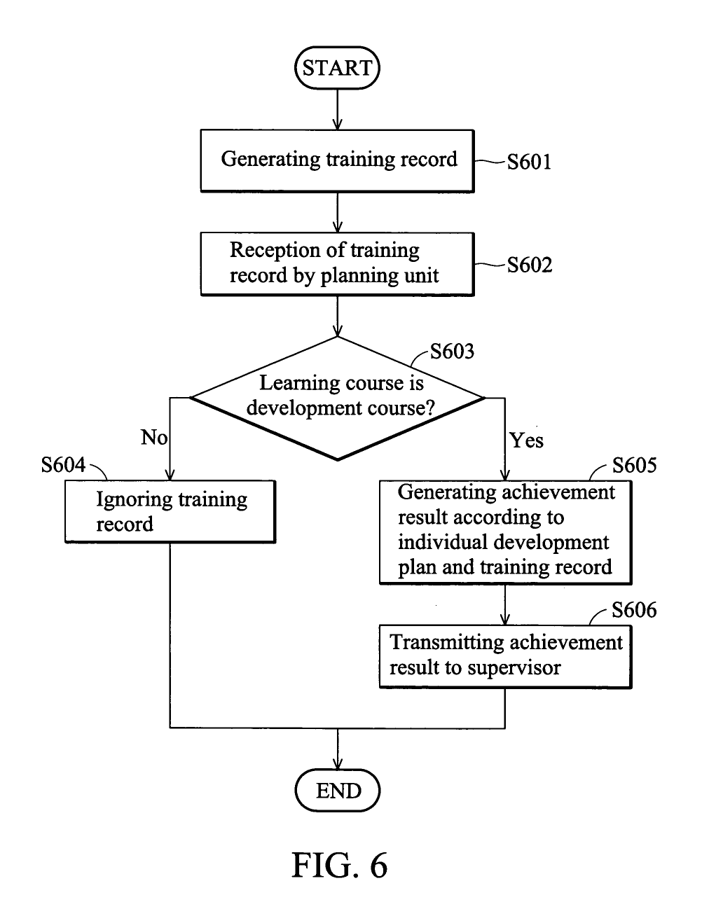

FIG. 6 shows the process of the method for individual development plan management according to the embodiment of the present invention.

First, in step S601, the training unit 220 generates a training record recording at least one course and a corresponding completion date, and in step S602, the planning unit 210 receives the training record from the training unit 220. In step S603, the planning unit 210 determines whether the learning course is the development course originally set in the individual development plan. If not (No in step S603), in step S604, the training record is ignored. If so (Yes in step S603), in step S605, the planning unit 210 generates an achievement result according to the individual development plan and the training record. It is noted that the planning unit 210 also compares the completion date with the allotted date originally set in the individual development plan, and makes a note of late or on-time completion of the achievement result. After the achievement result is generated, in step S606, the planning unit 210 transmits the achievement result to the supervisor 240 via the platform 200.

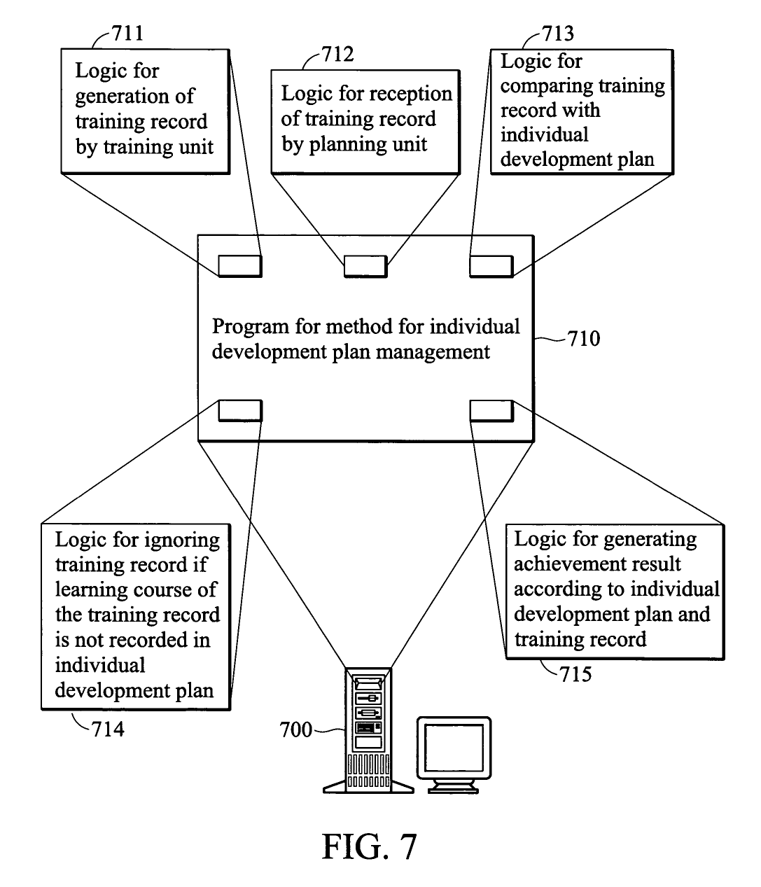

FIG. 7 is a diagram of a storage medium storing a computer program providing the method for individual development plan management according to the present invention. The computer program product comprises a storage medium 710 having computer readable program code embodied in the medium for use in a computer system 700, the computer readable program code comprising at least computer readable program code 711 generating of a training record by a training unit, computer readable program code 712 receiving of training records by a planning unit, computer readable program code 713 comparing the training record with an individual development plan, computer readable program code 714 ignoring the training record if a learning course of the training record is not recorded in the individual development plan, and computer readable program code 715 generating an achievement result according to the individual development plan and the training record if the learning course of the training record is recorded in the individual development plan.

The present invention thus provides a computerized system and method for individual development plan management that generates individual development plans by collaboration of individuals and supervisors, and traces achievement of individual development plans, thereby improving planning efficiency and promoting professional development.

The method and system of the present invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The method and systems of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to application specific logic circuits.

Although the present invention has been described in its preferred embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

What is claimed is:

1. A system for individual development plan management, comprising:
a training unit to generate a training record; and
a planning unit comprising an individual development plan coupled to the training unit to receive the training record, and to generate an achievement result according to the individual development plan and the training record.

2. The system of claim 1 wherein the training record records at least a completion date of a course, the individual development plan records at least one development course and a corresponding allotted date, and the planning unit compares the completion date with the allotted date to generate the achievement result if the course is the development course.

3. The system of claim 1 wherein the planning unit further transmits the achievement result to a supervisor via a network.

4. The system of claim 2 wherein the planning unit further ignores the training record if the course is not the development course.

5. The system of claim 2 wherein the course is completed through electronic, classroom, or on-the job training.

6. The system of claim 1 wherein the individual development plan is generated by collaboration between a client and a supervisor.

7. The system of claim 6 wherein a course plan is generated by the client and transmitted to the supervisor for approval as the individual development plan.

8. The system of claim 7 wherein the training unit and the planning unit are integrated via a web-based platform.

9. The system of claim 8 wherein the course plan is further modified by the client via the platform, the platform further notifies the supervisor of the modification for approval.

10. The system of claim 8 wherein the course plan is further modified by the supervisor via the platform, and the platform further notifies the client of the modification, and updates the individual development plan.

11. A method for individual development plan management, comprising the steps of:
generating a training record by a training unit;
providing a planning unit coupled to the training unit, comprising an individual development plan, and receiving the training record; and
generating an achievement result according to the individual development plan and the training record.

12. The method of claim 11 further comprising the step of transmitting the achievement result to a supervisor via a network.

13. The method of claim 11 wherein the training record records at least a completion date of a course, the individual development plan records at least one development course and a corresponding allotted date, and the planning unit compares the completion date with the allotted date to generate the achievement result if the course is the development course.

14. The method of claim 13 further comprising the step of ignoring the training record if the course is not the development course.

15. The method of claim 13 wherein the course is completed through electronic, classroom, or on-the job training.

16. The method of claim 11 further comprising the step of generating the individual development plan by collaboration between a client and a supervisor.

17. The method of claim 16 further comprising the steps of generating and transmitting a course plan to the supervisor by the client, and transmitting the course plan to the planning unit as the individual development plan by the supervisor if the course plan is approved.

18. The method of claim 17 further comprising the step of returning the course plan to the client by the supervisor if the course plan is not approved.

19. The method of claim 17 wherein the training unit and the planning unit are integrated via a web-based platform.

20. The method of claim 19 further comprising the steps of logging onto the platform and modifying the course plan by the client, notifying the supervisor of the modification by the platform, and transmitting the modified course plan to the planning unit for modification of the individual development plan by the supervisor if the modified course plan is approved.

21. The method of claim 19 further comprising the steps of logging into the platform and modifying the course plan by the client, notifying the supervisor of the modification by the platform, and returning the modified course plan to the client if the modified course plan is not approved.

22. The method of claim 19 further comprising the steps of logging onto the platform, modifying the course plan, and transmitting the modified course plan to the planning unit for modification of the individual development plan by the supervisor.

23. The method of claim 22 further comprising of the step of notifying the client of the modification by the platform.

24. A machine-readable storage medium storing a computer program which when executed causes a computer to perform a method for individual development plan management, the method comprising the steps of:
generating of a training record by a training unit;
providing an individual development plan on a planning unit, and receiving the training record; and
generating an achievement result according to the individual development plan and the training record.

25. The storage medium of claim 24 wherein the method further comprises the step of transmitting the achievement result to a supervisor via a network.

26. The storage medium of claim 24 wherein the training record records at least a completion date of a course, the individual development plan records at least one development course and a corresponding allotted date, and the planning unit compares the completion date with the allotted date to generate the achievement result if the course is the development course.

27. The storage medium of claim 26 wherein the method further comprises the step of ignoring the training record if the course is not the development course.

28. The storage medium of claim 26 wherein the course is completed through electronic, classroom, or on-the job training.

29. The storage medium of claim 24 wherein the method further comprises the step of generating the individual development plan by collaboration between a client and a supervisor.

30. The storage medium of claim 29 wherein the method further comprises the steps of generating and transmitting a course plan to the supervisor by the client, and transmitting the course plan to the planning unit as the individual development plan by the supervisor if the course plan is approved.

31. The storage medium of claim 30 wherein the method further comprises the step of returning the course plan to the client by the supervisor if the course plan is not approved.

32. The storage medium of claim 30 wherein the training unit and the planning unit are integrated via a web-based platform.

33. The storage medium of claim 32 wherein the method further comprises the steps of logging onto the platform and modifying the course plan by the client, notifying the supervisor of the modification by the platform, and transmitting the modified course plan to the planning unit for modification of the individual development plan by the supervisor if the modified course plan is approved.

34. The storage medium of claim 32 wherein the method further comprises the steps of logging into the platform and modifying the course plan by the client, notifying the supervisor of the modification by the platform, and returning the modified course plan to the client if the modified course plan is not approved.

35. The storage medium of claim 32 wherein the method further comprises the steps of logging onto the platform, modifying the course plan, and transmitting the modified course plan to the planning unit for modification of the individual development plan by the supervisor.

36. The storage medium of claim 35 wherein the method further comprises of the step of notifying the client of the modification by the platform.
